(19) United States
(12) Patent Application Publication
(10) Pub. No.: US 2013/0314618 A1
(43) Pub. Date: Nov. 28, 2013

(54) METHOD OF DRIVING DISPLAY DEVICE, DRIVING DEVICE OF DISPLAY DEVICE, AND TELEVISION DEVICE

(71) Applicant: Ryo Yamakawa, Osaka-shi (JP)

(72) Inventor: Ryo Yamakawa, Osaka-shi (JP)

(73) Assignee: SHARP KABUSHIKI KAISHA, Osaka-shi, Osaka (JP)

(21) Appl. No.: 13/983,731

(22) PCT Filed: Feb. 1, 2012
(86) PCT No.: PCT/JP2012/052252

§ 371 Date: Aug. 5, 2013

(30) Foreign Application Priority Data
Feb. 8, 2011 (JP) 2011-025189

(51) Int. Cl. G09G 3/36; G09G 5/00

(52) U.S. Cl. CPC G09G 3/3648; G09G 5/00
USPC 348/790; 345/84; 345/90

(57) ABSTRACT

In driving a liquid crystal panel of a liquid crystal display device of the present invention, when voltage applied to a gate line G1 is lowered to switch off a pixel P1, voltage applied to a gate line G2 and a gate line G3 rises to switch on a pixel P2 and a pixel P3. In such a case, timing t1 at which the voltage applied to the gate line G1 drops is set to be different from timing t3 at which the voltage applied to the gate lines G2, G3 rises. According to the driving method, ripples each having amplitude Vu1 and Vd1 that are generated in the storage capacitor line CS1 are less likely to be cancel out and attenuated. This improves display quality.

### TECHNICAL FIELD

The present invention relates to a method of driving a display device, a driving device of a display device, and a television device that reduces difference between amplitude of ripples generated in each of a plurality of storage capacitor lines.

### BACKGROUND ART

A high quality display device such as a large screen television has been widely used (for example, Patent Documents 1 and 2). Such a display device includes a plurality of display pixels. A signal is input to each of the display pixels via a wiring such as a gate line and a source line. Accordingly, each of the display pixels is controlled independently and the input signal is maintained with a storage capacitor that is provided between the display pixel and the storage capacitor line. Thus, a display image is formed on the display device.

To improve a 3D display property and a view angle property, a technology of high-speed driving is required in such a display device. As a method of driving the display device at a high speed, a “double source panel” has been used. In the double source panel, two source lines are arranged for each of display pixel groups that are aligned along a source line. In driving the double source panel, two display pixels that are arranged adjacent to each other in a source line direction, and the two display pixels are simultaneously controlled. Namely, to input a signal to a display pixel, a voltage applied to two gate lines that are arranged adjacent to each other is simultaneously switched to an on-voltage and a corresponding signal is input to each of the two source lines. After the signal is input to the display pixel, the voltage applied to the two gate lines is simultaneously switched to an off-voltage. In the display device including such a double source panel, two display pixels are controlled simultaneously and this enables high-speed driving compared to a display device that controls only one display pixel once.
Patent Document 1: Japanese Unexamined Patent Application Publication No. Hei 11-183874
Patent Document 2: Japanese Unexamined Patent Application Publication No. 2009-63938

### Problem to be Solved by the Invention

However, in the display device including the double source panel, difference between amplitude of ripples caused in the storage capacitor line may be increased compared to the conventional display device. The storage capacitor line is arranged between the adjacent gate lines and ripple is generally generated according to the change in voltage that is applied to the adjacent gate lines. In the conventional display device, if the voltage applied to one of the gate lines adjacent to the storage capacitor line is switched to an on-voltage, the voltage applied to another one of the gate lines is switched to an off-voltage, or maintained to be an off-voltage. Therefore, effects of the adjacent gate lines are cancelled out and the ripples caused in the storage capacitor line is attenuated, or the ripples caused in the storage capacitor line has effects of one of the adjacent gate lines.

In the display device including the double source panel, if the voltage applied to one of the gate lines adjacent to the storage capacitor line is switched to an on-voltage, the voltage applied to the other one of the gate line may be switched to an off-voltage or may be switched to an on-voltage. Therefore, the effects of the adjacent gate lines may be cancelled out and the ripples caused in the storage capacitor line may be attenuated or the effects of the adjacent gate lines may be enhanced and the ripples caused in the storage capacitor line may be amplified. Accordingly, difference between the amplitude of the ripples caused in each of the storage capacitor lines. If difference between the amplitude of the ripples caused in the storage capacitor line increases, difference in the shift amount of the voltage value of the signal applied to the display pixel shifting from the storage capacitor line also increases. This deteriorates display quality.

### DISCLOSURE OF THE PRESENT INVENTION

The present invention was accomplished in view of the foregoing circumstances. An object of the present invention is to reduce difference in amplitude of ripples caused in a plurality of storage capacitor lines and improve display quality.

### Means for Solving the Problem

To solve the above problem, the present invention provides a method of driving a display device that includes gate lines and source lines cross each other, display pixels each including a switching component and a pixel electrode and arranged for each crossing point, and storage capacitor lines that generate a storage capacitor between each storage capacitor line and each pixel electrode. For a first display pixel connected to a first gate line, a second display pixel connected to a second gate line that is arranged adjacent to the first gate line, and a third display pixel connected to a third gate line that is arranged adjacent to the second gate line and on a different side from the first gate line, in lowering a voltage applied to the first gate line to switch off the first display pixel, a voltage applied to the second gate line and the third gate line is raised to switch on the second image pixel and the third display pixel, and first timing at which the voltage applied to the first gate line drops and second timing at which the voltage applied to the second gate line and the third gate line rises are set such that the first timing is different from the second timing.

According to the display device, in the first storage capacitor line that is arranged between the adjacent first gate line and the second gate line, a negative ripple in which the voltage temporally changes to be negative is generated at the first timing due to influence of the first gate line, and a positive ripple in which the voltage temporally changes to be positive is generated at the second timing due to influence of the second gate line. In the second storage capacitor line that is arranged between the adjacent second gate line and the third gate line, a positive ripple is generated at the second timing due to influence of the second gate line, and a positive ripple is generated at the second timing due to influence of the third gate line. Namely, in the second storage capacitor line, the ripples generated due to influence of the second gate line and the third gate line at the second timing are combined and an amplified ripple is generated.

According to the driving method of the display device, the first timing is different from the second timing. Therefore, unlike the case in which the first timing is set to be same as the second timing, the ripple generated in the first storage capacitor line due to the influence of the first gate line and the ripple generated in the first storage capacitor line due to the influence of the second gate line are less likely to be combined and an attenuated ripple is less likely to be generated. Accordingly, the ripples generated in the storage capacitor line may not include both of an attenuated ripple and an amplified ripple. Difference in amplitude of the ripples generated in each of the storage capacitor lines is less likely to increase. This improves display quality.

In the driving method of the display device, the display device may further include a fourth display pixel connected to a fourth gate line that is arranged adjacent to the third gate line and on a different side from the second gate line, and in decreasing the voltage applied to the second gate line and the third gate line to switch off the second display pixel and the third display pixel, a voltage applied to the fourth gate line may be raised to switch on the fourth display pixel. Third timing at which the voltage applied to the second gate line and the third gate line drops and fourth timing at which the voltage applied to the fourth gate line rises may be set such that the third timing is different from the fourth timing.

In the display device, in the second storage capacitor line, a negative-side ripple is generated at the third timing due to influence of the second gate line and a negative-side ripple is generated at the third timing due to influence of the third gate line. Namely, in the second storage capacitor line, the ripples generated due to influence of the second gate line and the third gate line at the third timing are combined and an amplified ripple is generated. In the third storage capacitor line that is arranged between the adjacent third gate line and a fourth gate line, a negative-side ripple is generated at the third timing due to influence of the third gate line and a positive-side ripple is generated at the fourth timing due to influence of the fourth gate line.

In the driving method of the display device, the third timing is set to be different from the fourth timing. Therefore, unlike the case in which the third timing is set to be same as the fourth timing, in the third storage capacitor line, the ripples generated due to influence of the third gate line and the fourth gate line are less likely to be combined and an attenuated ripple is less likely to be generated. Therefore, the ripple generated in the storage capacitor line may not include both of an amplified ripple and an attenuated ripple, and difference in amplitude of ripples generated in each storage capacitor line is less likely to increase. This improves display quality.

In the driving method of the display device, in decreasing the voltage applied to the second gate line and the third gate line, at fifth timing prior to the third timing, the voltage applied to the second gate line and the third gate line may be switched from an on-voltage to an intermediate voltage that is between the on-voltage and an off-voltage. At the third timing, the voltage applied to the second gate line and the third gate line may be switched from the intermediate voltage to the off-voltage to lower the voltage.

In the driving method of the display device, in decreasing the voltage applied to the second gate line and the third gate line, the voltage applied to the gate lines is changed at two timings including the fifth timing and the third timing and switched from an on-voltage to an off-voltage. Compared to the case in which the voltage is switched from the on-voltage to the off-voltage at the third timing, the variation amount of the voltage at the third timing is less likely to increase. Generally, amplitude of a ripple generated in the storage capacitor line is proportional to the variation value of the voltage that is applied to the gate line. According to the driving method of the display device, the variation amount in the voltage applied to the second gate line and the third gate line at the third timing is less likely to increase. Accordingly, amplitude of an amplified ripple generated in the second storage capacitor line at the third timing is less likely to increase. Therefore, difference in amplitude of ripples generated in each storage capacitor line is less likely to increase and this improves display quality.

In the driving method of the display device, the display device may further include a counter board on which a counter electrode is arranged and that is arranged to face aboard on which the display pixels are arranged, and a voltage generation circuit configured to generate a voltage that is applied to the gate line to control flicker that is generated between the counter electrode and the pixel electrode of the display pixel that is arranged to face the counter electrode. The voltage generation circuit may generate the intermediate voltage that is applied to the gate line at the fifth timing.

If a flicker is caused between a pixel electrode included in the display pixel of the display device and a counter electrode, a technology is known that intermediate voltage is applied to a gate line connected to the display pixel such that the flicker is less likely to occur. The display device that can execute the above technology includes a circuit that generates an intermediate voltage in the gate line. With the circuit, the intermediate voltage that is to be applied to the gate line is generated. In the driving method of the display device, with using the circuit arranged to reduce occurrence of the flicker in the display device, intermediate voltage is generated to reduce difference in amplitude of the ripples generated in each of the storage capacitor lines. This simplifies a configuration of the display device.

The present invention may be applied to a driving device of a display device that executes the driving method. A driving device of a display device of the present invention includes pixels each including a switching component and a pixel electrode and arranged for each crossing point, and storage capacitor lines that generate a storage capacitor between each storage capacitor line and each pixel electrode. The driving device includes a voltage applier configured to apply voltage to the gate line, and a setter configured to set timing at which the voltage applier applies the voltage to the gate line. For a first display pixel connected to a first gate line, a second display pixel connected to a second gate line that is arranged adjacent to the first gate line, and a third display pixel connected to a third gate line that is arranged adjacent to the second gate line and on a different side from the first gate line, in lowering a voltage applied to the first gate line to switch off the first display pixel, a voltage applied to the second gate line and the third gate line is raised to switch on the second image pixel and the third display pixel. The setter sets first timing at which the voltage applied to the first gate line drops and second timing at which the voltage applied to the second gate line and the third gate line rises such that the first timing is different from the second timing.

According to the driving device of the display device, the first timing and the second timing are set to be same. Therefore, the ripples generated in the storage capacitor line are less likely to include both of an attenuated ripple and an amplified ripple. Therefore, difference in amplitude of ripples generated in each of the storage capacitor lines is less likely to increase and this improves display quality.

In the driving device of the display device, the display device may be a liquid crystal display device using a liquid crystal panel. According to the driving device of the display device, in the storage capacitor lines arranged in the liquid crystal panel, difference in amplitude of the ripples generated in each of the storage capacitor lines is less likely to increase. This improves display quality of a liquid crystal display device using the liquid crystal panel.

The present invention may be applied to a television device that includes the driving device of a display device according to one of claims 5 and 6, and a display device. According to the television device, difference in the amplitude of ripples generated in each of the storage capacitor lines arranged in the display device is less likely to increase, and this improves display quality of the television device.

### Advantageous Effect of the Invention

According to the present invention, difference in amplitude of ripples caused in each of storage capacitor lines is less likely to increase and display quality is improved.

### BRIEF DESCRIPTION OF THE DRAWINGS

FIG. 1 is a view illustrating a configuration of a liquid crystal display device.

FIG. 2 is an equivalent circuit of a pixel.

FIG. 3 is a flowchart of a display process.

FIG. 4 is a timing chart of an embodiment.

FIG. 5 is a timing chart of a related art.

FIG. 6 is a timing chart of another embodiment.

FIG. 7 is a timing chart of another different embodiment.

### MODES FOR CARRYING OUT THE INVENTION

### First Embodiment

A first embodiment will be explained with reference to drawings.

(1. Configuration of Liquid Crystal Display Device)

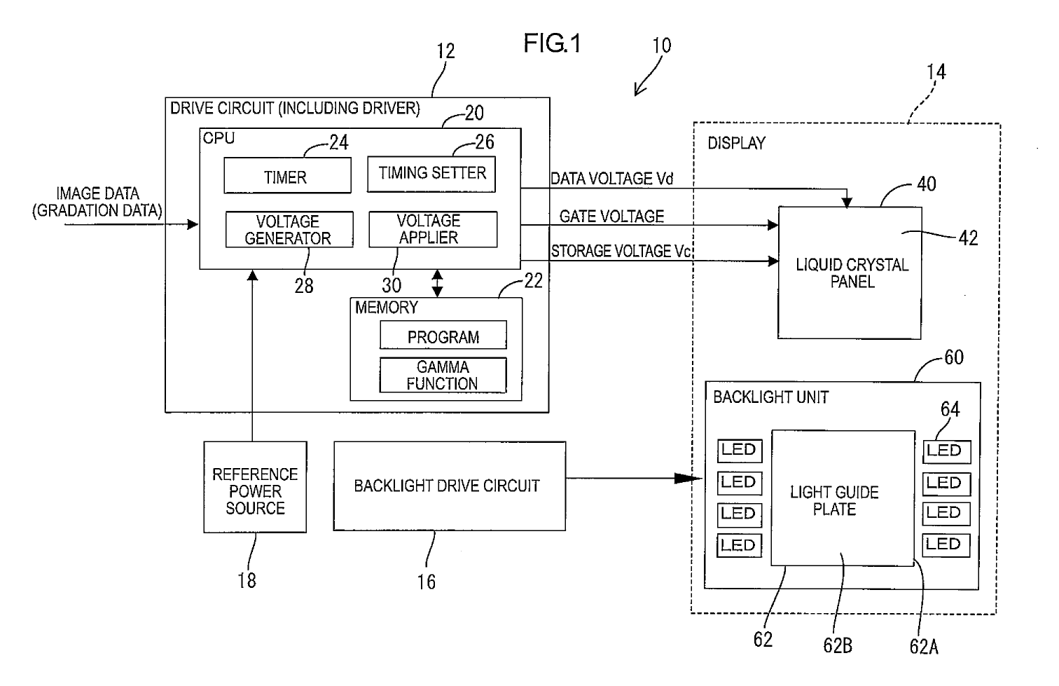

As illustrated in FIG. 1, a liquid crystal display device 10 is a display device for a television receiver and includes a drive circuit 12, a display 14, a backlight drive circuit 16 and a power source device 18. The display 14 includes a liquid crystal panel 40 and a backlight unit 60.

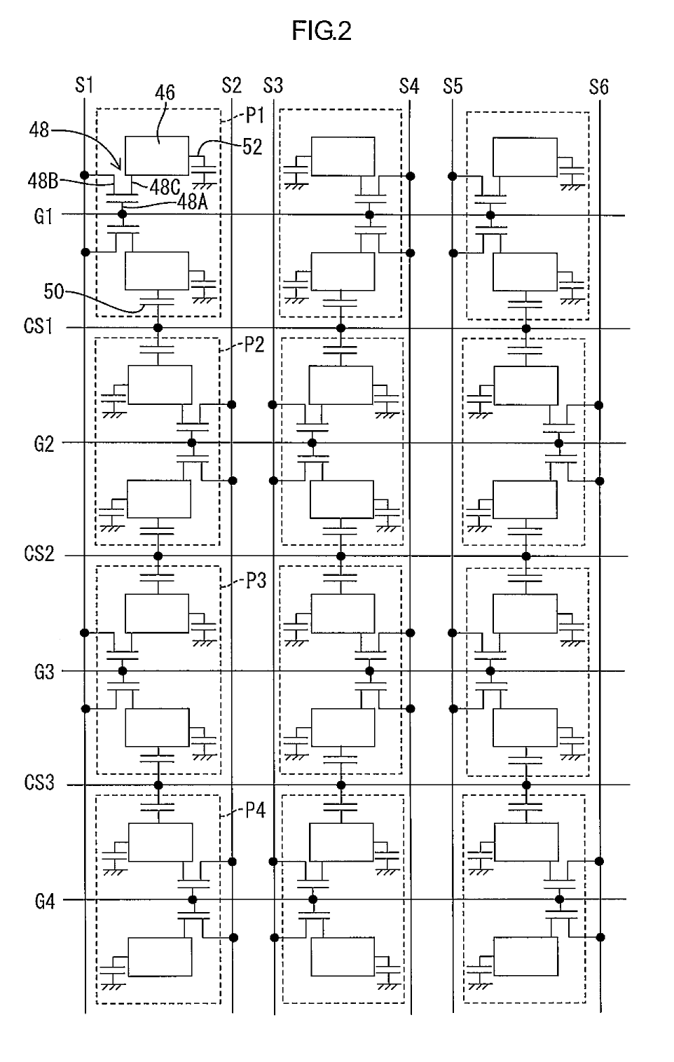

The liquid crystal panel 40 includes a display area 42. FIG. 2 illustrates an equivalent circuit of the display area 42. The display area 42 includes a plurality of gate lines G, a plurality of source lines S, a plurality of pixels (one of examples of a display pixel) P, and a plurality of storage capacitor lines CS. The gate lines G are formed of a conductive material such as aluminum and arranged to extend in parallel to a paper lateral direction. The source lines S are formed of a conductive material such as aluminum and arranged to extend in parallel to a paper vertical direction. In the display area 42, the gate lines G and the source lines S cross to be orthogonal to each other and the pixel P is arranged on each crossing point in which the gate lines G and the source lines S cross.

The pixel P is a unit display component for driving the liquid crystal panel 40. Each pixel P includes two switching components 48 and two pixel electrodes (one of examples of pixel electrode) 46. The switching component 48 includes a switch electrode 48A and data electrodes 48B, 48C. The switch electrode 48A is connected to the corresponding gate line G. The data electrode 48B is connected to the corresponding source line S, and the data electrode 48C is connected to the pixel electrode 46. The pixel electrode 46 is an electrode formed of a conductive material such as an ITO and arranged to face a counter electrode 52 that is connected to a ground voltage via liquid crystal molecules enclosed in the liquid crystal panel 40.

Two switching components 48 included in the same pixel P are connected to the same gate line G. The two switching components 48 included in the same pixel P are connected to the same source line S. The pixels P that are arranged along the gate line G are connected to the same gate line G.

The pixels P that are arranged along the source line S are not necessarily connected to the same source line S. The liquid crystal panel 40 of the present embodiment is a double source panel and two source lines S (for example, source lines S1, S2) are arranged for the pixels P that are arranged along the source line S. If one of the pixels P is connected to one source line S, another one of the pixels P that is located adjacent to the one pixel P along the source line S is connected to another source line S. Among the pixels P1, P2, P3, P4 that are arranged along the source lines S1, S2, the pixels P1, P3 are connected to the source line S1 and the pixels P2, P4 are connected to the source line S2.

The storage capacitor line CS is made of a conductive material such as aluminum and extends along a paper lateral direction. The storage capacitor line CS is arranged between adjacent gate lines G and between adjacent pixels P that are arranged along the source line S. The pixel electrode 46 included in the pixel P is insulated from the storage capacitor line CS via insulation. The pixel electrode 46 is arranged to face the adjacent storage capacitor line CS via the insulation, and a storage capacitor 50 is generated between the pixel electrode 46 and the adjacent storage capacitor line CS.

The storage capacitor 50 is generated between the storage capacitor line CS and the pixel electrode 46 included in each of the pixels P that are arranged adjacent to the storage capacitor line CS along the source line S. Therefore, the storage capacitor line CS has effects from one of the gate lines G adjacent to the storage capacitor line CS via the pixel electrode 46 included in one of the adjacent pixels arranged along the source line S. The storage capacitor line CS has effects from another one of the gate lines G adjacent to the storage capacitor line CS via the pixel electrode 46 included in another one of the adjacent pixels arranged along the source line S. Namely, the storage capacitor line CS receives effects from both of the adjacent gate lines G.

The backlight unit 60 is arranged on a rear surface side of the liquid crystal panel 40. The backlight unit 60 includes LEDs 64 (light emitting diodes) 64 as a light source and a light guide plate 62. The LEDs 64 are arranged to face a side surface of the light guide plate 62. The light guide plate 62 is arranged such that its main surface faces the liquid crystal panel 40. The light guide plate 62 guides light from the LED 64 entering the side surface thereof toward the main surface. The side surface of the light guide plate 62 functions as a light entrance surface 62A that guides the light irradiated from the LEDs 64 into the light guide plate 62. The main surface of the light guide plate 62 functions as a light exit surface 62B from which the light traveling through the light guide plate 62 exits toward the liquid crystal panel 40. Thus, the LEDs 64 are arranged on two end portions along the long side of the backlight unit 60 and the light guide plate 62 is arranged in a middle portion thereof, and the backlight unit 60 is a backlight unit of an edge light type (a side light type).

The backlight drive circuit 16 is connected to the LEDs 64 that configure the backlight unit 60 and drives the LEDs 64. The backlight drive circuit 16 supplies current to each of the LEDs 64 and controls an amount of current supplied to the LED 64 to control an amount of light entering the light guide plate 62 from each LED 64.

The power source device 18 is connected to the drive circuit 12 and supplies a plurality of reference voltages V to the drive circuit 12 that are required to generate various voltages for display on the liquid display panel 40. The reference voltage V includes at least on-voltage Von and off-voltage Voff. The on-voltage Von is necessary to turn on the switching component included in the pixel P of the liquid crystal panel 40.

The drive circuit 12 includes a central processing unit (CPU) 20 and a memory 22 configured with a ROM, a RAM, and the like. The memory 22 stores programs, gamma functions and the like. The CPU 20 functions as a timer 24, a timing setter 26, a voltage generator 28, a voltage applier 30 and the like according to a program read from the memory 22. If image data configured with gradation value data is input from an external device, the CPU 20 generates various voltages required for display on the liquid crystal panel 40 and applies the generated voltage to the liquid crystal panel 40 at a predetermined timing.

(2. Display Process)

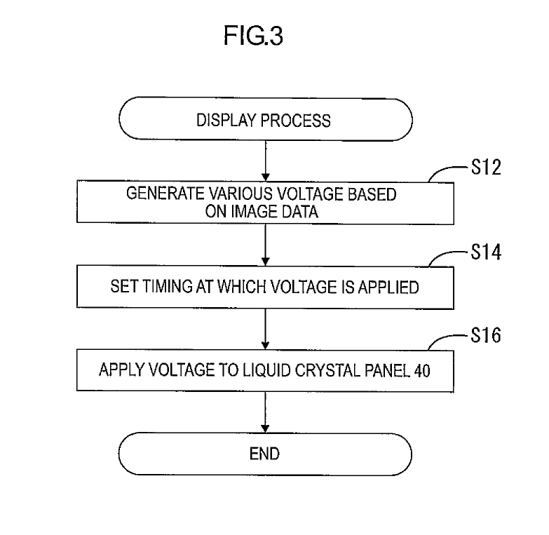

A display process of the liquid display device 10 will be explained with reference to FIGS. 3 to 6.

As illustrated in FIG. 3, the CPU 20 of the drive circuit 12 starts the process in response to input of image data from an external device and generates various voltages (S12). The CPU 20 functions as a voltage generator (one of examples of the voltage generation circuit) and generates a data voltage Vd using a reference voltage V supplied from the power source device 18 and a gamma function stores in the memory 22. The data voltage Vd is applied to the source line S from the image data. The CPU 20 determines a data voltage Vd corresponding to the image data with using a gamma function, and generates the data voltage Vd with using the reference voltage supplied from the power source device 18. The CPU 20 generates a gate voltage (on-voltage Von and off-voltage Voff) that is applied to the gate line G and a storage voltage Vc that is applied to the storage capacitor line CS with using the reference voltage V.

Next, the CPU 20 sets a timing at which the generated gate voltage is applied (S14). The CPU 20 functions as the timer 24 and the timing setter (one of examples of the setter) 26. After starting the liquid crystal display device 10, the CPU 20 counts elapsed time T after starting control. With using the elapse time T, the CPU 20 sets a timing at which the voltage is applied to the gate line G, the source line S, and the storage capacitor line CS that are connected to the same pixel P.

With using the elapsed time, the CPU 30 sets a timing at which the voltage is applied to each of the lines formed in the liquid crystal panel 40. For example, the gate lines G are formed in the liquid crystal panel 40, the on-voltage Von is input to each of the gate lines G sequentially and all the pixels P included in the liquid crystal panel 40 are able to be displayed. With using the elapsed time T, the CPU 20 sets a timing (a voltage raising timing) at which the voltage applied to each of the gate lines G is switched from the off-voltage Voff to the on-voltage Von and a timing (a voltage lowering timing) at which the voltage applied to each of the gate lines G is switched from the on-voltage Von to the off-voltage Voff.

Next, the CPU 20 applies the generated various voltages to the liquid crystal panel at the set timing (S16). The CPU 20 functions as the voltage applier. The CPU 20 is connected to each line arranged in the liquid crystal panel 40 and applies the generated voltages to a corresponding line.

In the liquid crystal panel 40, if the gate voltage applied to the gate line G of the pixel P that is to be controlled is switched from the off-voltage Voff to the on-voltage Von, the switching component 48 of the pixel P is switched to be on.

In the liquid crystal panel 40, in synchronism with the switching of the switching component 49 of the pixel P to be on, application of the data voltage Vd to the source line S is started. The applied data voltage Vd is applied to the pixel electrode 46 via the data electrodes 48B, 48C. If the data voltage Vd is applied to the pixel electrode 46, liquid crystal molecules located corresponding to the pixel electrode 46 are polarized and light transmission of the pixel P changes. In the display 14, light having predetermined brightness is irradiated from the backlight unit 60 toward the liquid crystal panel 40. The backlight unit 60 is arranged on the rear-surface side of the liquid crystal panel 40. The transmission of the pixel P changes, and accordingly, display brightness of the pixel P also changes. The transmission of the liquid crystal molecules of the pixel P changes in various ways according to the data voltage Vd. Accordingly, the pixel P is controlled to have desired display brightness.

If a predetermined display period has passed after the gate voltage applied to the gate line G is switched from the off-voltage Voff to the on-voltage Von, it is determined whether the gate voltage applied to the gate line G is switched from the on-voltage Von to the off voltage V-off. If determined that the gate voltage applied to the gate line G is switched from the on-voltage Von to the off-voltage Voff, the switching component of the pixel P is switched to be off. In synchronism with the switching of the switching component 48 of the pixel P to be off, the application of the data voltage Vd to the source line S is stopped. Accordingly, the voltage of the pixel electrode 46 is maintained to be the voltage just before switching off the switching component 48.

Prior to the application of the data voltage Vd to the pixel electrode 46, the storage voltage Vc is applied to the storage capacitor line CS. Accordingly, the voltage of the pixel electrode 46 is maintained and the display brightness of the pixels P is maintained during a predetermined display period.

(3. Application Timing)

As illustrated in FIG. 2, according to the present embodiment, the double source panel is used as the liquid crystal panel 40, and two pixels P are simultaneously controlled. Therefore, in the liquid crystal panel 40 of the present embodiment, two pixels P (for example, pixel P2, P3) that are arranged along the source line S can be controlled simultaneously. For example, when applying a voltage to the pixels P2, P3, the voltage applied to the gate lines G2, G3 are simultaneously switched from the off-voltage to the on-voltage, and the data voltage Vd corresponding to each pixel P is input to the source lines S1, S2. When stopping the application of the voltage to the pixels P2, P3, the voltage applied to the gate lines G2, G3 is simultaneously switched from the on-voltage to the off-voltage. Similarly, the pixel P1 and the pixel P that is arranged on an upper side from the pixel P1 in the drawing are controlled simultaneously with each other. The pixel P4 is controlled simultaneously with the pixel P that is arranged on a lower side from the pixel P4 in the drawing than the pixel 4.

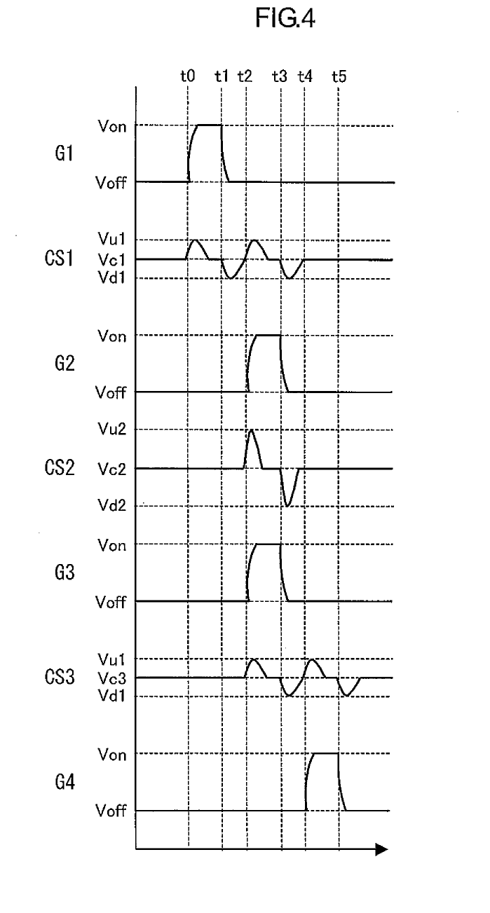

FIG. 4 illustrates voltage change in the gate lines G1-G4 and the storage capacitor lines CS1-CS3 during a period while the pixels P1-P4 are controlled by a driving method of the present embodiment. Vu represents positive voltage side amplitude of a ripple that is generated in the storage capacitor line CS. Vd represents negative voltage side amplitude of a ripple that is generated in the storage capacitor line CS. During a period illustrated in FIG. 4, the constant storage voltage Vc is applied from the drive circuit 12 to each of the storage capacitor lines CS1 to CS3.

As illustrated in FIG. 4, according to the driving method of the present embodiment, the voltage applied to the gate line G1 is switched (raised) from the off-voltage Voff to the on-voltage Von at a timing t0. The gate line G1 is connected to the pixel P1, and a ripple having amplitude Vu1 is generated in the storage capacitor line CS1 that is connected to the pixel P1 via the storage capacitor 50.

Next, the voltage applied to the gate line G1 is switched (lowered) from the on-voltage Von to the off-voltage Voff at a timing t1 (one of examples of first timing). The voltage applied to the gate lines G2, G3 is maintained to be the off-voltage Voff and the voltage applied to the gate lines G2, G3 is not raised. Accordingly, a ripple having amplitude Vd1 is generated in the storage capacitor line CS1.

Next, the voltage applied to the gate lines G2, G3 is raised at a timing t2 (one of examples of second timing). A ripple having amplitude Vu1 is generated in the storage capacitor lines CS1, CS3. The pixels P2, P3 are connected to the gate lines G2, G3, respectively. The storage capacitor line CS2 is connected to the pixels P2, P3 via the storage capacitor 50. A ripple having the amplitude Vu1 is generated in each gate line G2, G3, and the generated ripples are combined to generate a ripple having amplitude Vu2. The amplitude Vu2 is greater than the amplitude Vu1 and is substantially twice as the amplitude Vu1.

The voltage applied to the gate lines G2, G3 is lowered at a timing t3 (one of examples of third timing). The voltage applied to the gate line G4 is maintained to be the off-voltage Voff, and the voltage applied to the gate line G4 is not raised. Accordingly, a ripple having amplitude Vd1 is generated in the storage capacitor lines CS1, CS3. A ripple having the amplitude Vd1 is generated in each of the gate lines G2, G3. The generated ripples are combined to generate a ripple having amplitude Vd2. The amplitude Vd2 is greater than the amplitude Vd1 and is substantially twice as the amplitude Vd1.

The voltage applied to the gate line G4 is raised at a timing t4 (one of examples of fourth timing). Accordingly, a ripple having the amplitude Vu1 is generated in the storage capacitor line CS3.

Next, the voltage applied to the gate line G4 is lowered at a timing t5. Accordingly, a ripple having the amplitude Vd1 is generated in the storage capacitor line CS3.

According to the driving method of the present embodiment, the voltage raising timing of one gate line G and the voltage lowering timing of another gate line G adjacent to the one gate line G are set to be different from each other. Therefore, if the gate voltage applied to the gate line G changes, a ripple is necessarily generated in the storage capacitor line CS that is arranged adjacent to the gate line G.

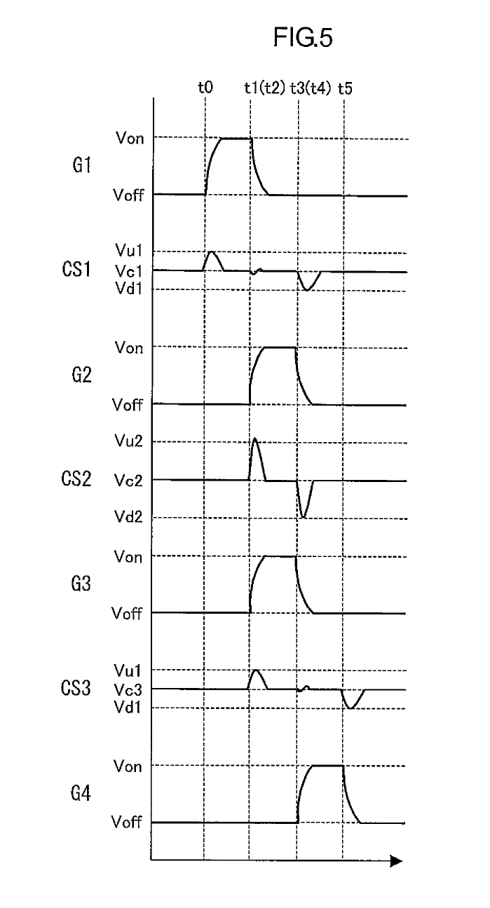

FIG. 5 illustrates change in voltage in the gate lines G1-G4 and the storage capacitor lines CS1-CS3 in case that the voltage raising timing in one gate line G and the voltage lowering timing in another gate line G adjacent to the one gate line are set to be same unlike the driving method of the present embodiment.

In such a case, the voltage applied to the gate line G1 is lowered at the timing t1 (timing t2), and the voltage applied to the gate lines G2, G3 is raised. Accordingly, the ripples generated in the storage capacitor line CS1 by the application of voltage to the gate lines G1, G2 cancel out and a ripple is less likely to be generated.

The voltage applied to the gate lines G2, 3 is lowered at a timing t3 (timing 4) and the voltage applied to the gate line G4 is raised. Accordingly, the ripples generated in the gate lines G3, 4 cancel out each other and substantially no ripple is generated in the storage capacitor line CS3.

If the voltage raising timing of one gate line G and the voltage lowering timing of another gate line G adjacent to the one gate line G is set to be same, no ripple may be generated in the storage capacitor line CS arranged adjacent to the one gate line G even if the gate voltage applied to the one gate line G is changed. Namely, a ripple having amplitude that is zero may be generated. Therefore, if the gate voltage applied to the one gate line G is changed, the ripple generated in the storage capacitor line CS that is arranged adjacent to the one gate line G has amplitude that is one of three values of 0, Vu1 (Vd1), Vu2 (Vd2).

According to the driving method of the present embodiment, if the gate voltage applied to the one gate line G is changed, the ripple generated in the storage capacitor line CS that is arranged adjacent to the one gate line G has amplitude that is either one of Vu1 (Vd1) and Vu2 (Vd2). Accordingly, compared to the case in which the voltage raising timing of one gate line G and the voltage lowering timing of another gate line G adjacent to the one gate line G is set to be same, difference between the amplitude of the ripples caused in the storage capacitor line CS is less likely to increase or less likely to be caused. Therefore, for example, if cancel voltage Vs is applied to cancel the generated ripple, the cancel voltage Vs can be determined precisely.

(4. Advantageous Effects of First Embodiment)

(1) In the present embodiment, the timing t1 at which the voltage applied to the gate line G1 drops is set to be different from the timing t2 at which the voltage applied to the gate lines G2, G3 rises. Therefore, the ripple caused in the storage capacitor line CS1 is less likely to be attenuated unlike the case in which the timing t1 is set to be same as the timing t2. Accordingly, unlike the case in which the timing t1 is set to be same as the timing t2, the generated ripple is less likely to be attenuated in the storage capacitor line CS1 and the generated ripple is less likely to be amplified in the storage capacitor line CS2. Therefore, difference between the amplitude of the ripple generated in the storage capacitor line CS1 and the ripple generated in the storage capacitor line CS2 is less likely to increase or less likely to be caused. This improves display quality.

(2) In the present embodiment, the timing t3 at which the voltage applied to the gate lines G2, G3 drops is different from the timing t4 at which the voltage applied to the gate line G4 rises. Therefore, unlike the case in which the timing t3 is set to be same as the timing t4, the ripple generated in the storage capacitor line CS3 is less likely to be attenuated. Accordingly, unlike the case in which the timing t3 is set to be same as the timing t4, the ripple generated in the storage capacitor line CS3 may not be increased, and the ripple generated in the storage capacitor line CS2 may not be attenuated, and difference between the amplitude of the ripple generated in the storage capacitor line CS2 and the amplitude of the ripple generated in the storage capacitor line CS3 is less likely to be increased or less likely to be caused. This improves display quality.

### Second Embodiment

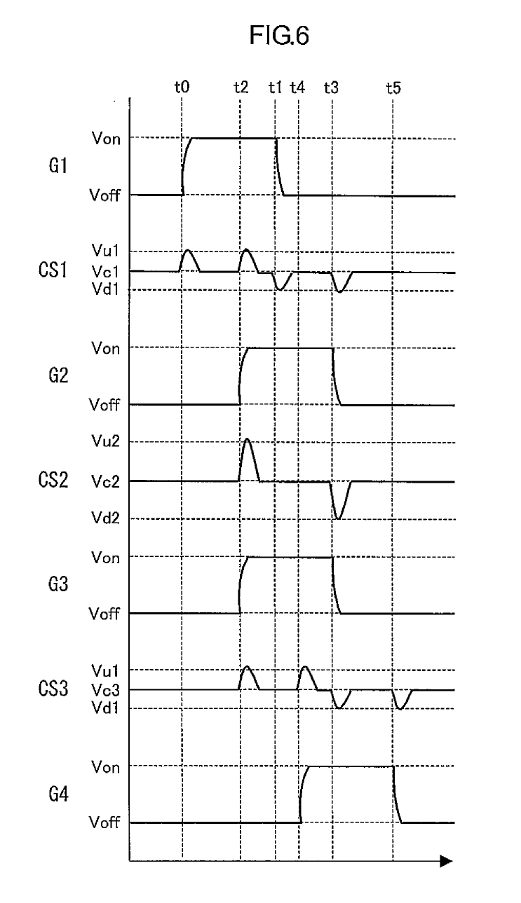

A second embodiment will be explained with reference to FIG. 6.

(1. Application Timing)

In a method of driving the liquid crystal display device 10 of the present embodiment, after the voltage applied to the gate lines G2, G3 rises, the voltage applied to the gate line G1 drops. In the method of driving the liquid crystal display device 10 of the first embodiment, after the voltage applied to the gate line G1 drops, the voltage applied to the gate lines G2, G3 rises. In the second embodiment, after the voltage applied to the gate line G4 rises, the voltage applied to the gate lines G2, G3 drops. In the method of driving the liquid crystal display device 10 of the first embodiment, after the voltage applied to the gate lines G2, G3 drops, the voltage applied to the gate line G4 rises.

(2. Advantageous Effects of Second Embodiment)

(1) In the second embodiment, the timing t1 at which the voltage applied to the gate line G1 drops is different from the timing t2 at which the voltage applied to the gate lines G2, G3 rises. The timing t3 at which the voltage applied to the gate lines G2, G3 drops is set to be different from the timing t4 at which the voltage applied to the gate line G4 rises. Accordingly, difference in the amplitude of the ripple generated in the storage capacitor lines CS1, CS3 and the amplitude of the ripple generated in the storage capacitor line CS2 is less likely to be increased. This improves display quality.

(2) In the second embodiment, a part of the period while the on-voltage Von is applied to the pixel P1 overlaps a part of the period while the on-voltage Von is applied to the pixel P3 that is to be controlled after the pixel P1. Similarly, a part of the period while the on-voltage Von is applied to the pixel P2 overlaps a part of the period while the on-voltage Von is applied to the pixel P4 that is to be controlled after the pixel P2. Accordingly, if the pixel P3 (P4) is controlled after control of the pixel P1 (P2), the liquid crystal display device 10 can be driven at high speed with eliminating a period while the on-voltage Von is not applied to any pixels P and any pixels cannot be controlled.

(3) According to the second embodiment, the on-voltage Von is applied for a predetermined period to a plurality of pixels P that are not to be controlled simultaneously. Therefore, in the second embodiment, in synchronism with switching off the switching component 48 of the pixel P that is controlled just before the current control, the application of the data voltage Vd to the source line S is started. Prior to switching on the switching component 48 of the pixel P that is to be controlled next to the current control, the application of the data voltage Vd to the source line S is terminated. Accordingly, application of the data voltage Vd to unintended pixels P is less likely to occur.

### Third Embodiment

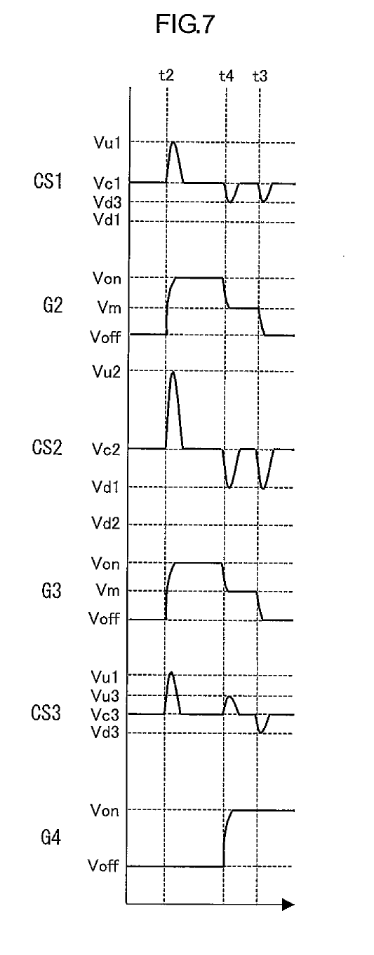

A third embodiment will be explained with reference to FIG. 7. In a method of driving the liquid crystal display device 10 of the third embodiment, in switching the voltage applied to the gate line G from the on-voltage Von to the off-voltage Voff, the voltage is switched from the on-voltage to intermediate half voltage (one of examples of intermediate voltage) Vm (=(Von+Voff)/2) that is set to be intermediate half voltage between the on-voltage Von and the off voltage Voff first. Then, the voltage is switched from the intermediate voltage Vm to the off-voltage Voff at a timing different from the timing at which the voltage is switched to the intermediate voltage Vm unlike the method of driving the liquid crystal display device 10 of the second embodiment in which the voltage is switched from the on-voltage Von to the off-voltage Voff at once. Hereinafter, an example of the second embodiment will be explained, and in the example, the voltage applied to the gate lines G2, G3 is changed at two different timings and switched from the on-voltage Von to the off-voltage Voff.

(1. Configuration of Liquid Crystal Display Device)

In the liquid crystal display device 10 of the third embodiment, the CPU 20 that functions as the voltage generator 28 changes the reference voltage V that is supplied from the power source device 18. The drive circuit 12 includes a circuit that switches wiring and changes resistance division to change the reference voltage V. The CPU 20 uses the circuit included in the drive circuit 12 and changes the reference voltage V that is supplied from the power source device 18.

In applying the intermediate voltage Vm to the gate lines G2, G3, the CPU 30 changes the on-voltage Von supplied from the power source device 18 and generates the intermediate voltage Vm. The CPU 30 applies the generated intermediate voltage Vm to the gate lines G2, G3.

The liquid crystal display device 10 has a so-called gate-slope function. Namely, in switching the voltage applied to the gate line G of the liquid crystal panel 40, the voltage changes smoothly such that poor change of the voltage that may be caused by the wiring resistance of the gate line G is less likely to have influence and in-plane flicker is less likely to occur. In switching the voltage applied to the gate line G, the CPU 30 generates a plurality of voltages that range between the on-voltage Von and the off-voltage Voff and smoothly changes the voltage applied to the gate line G.

In the liquid crystal display device 10 of the present embodiment, the intermediate voltage Vm is generated with using the gate slope function. Therefore, the intermediate voltage Vm is generated with using the function that the general drive circuit 12 has.

(2. Application Timing)

As illustrated in FIG. 7, in the driving method of the third embodiment, at the timing t3 the voltage applied to the gate lines G2, G3 is switched to the off-voltage Voff, and at the timing t4 that is prior to the timing t3, the voltage applied to the gate line G4 is switched from the off-voltage Voff to the on-voltage Von. At the timing t4 (one of examples of fifth timing), the voltage applied to the gate line G4 is switched from the off-voltage Voff to the on-voltage Von and the voltage applied to the gate lines G2, G3 is switched from the on-voltage Von to the intermediate voltage Vm. Accordingly, the ripples are generated in the storage capacitor lines CS1, CS2, CS3.

The ripple having the amplitude Vd3 is generated in the storage capacitor line CS1 due to the effects of the gate line G1. The amplitude of the ripple generated in the storage capacitor line CS is proportional to the change in voltage that is generated in the adjacent gate line G. Therefore, the amplitude Vd3 is smaller than the amplitude Vd1 of the ripple that is generated according to the switching from the on-voltage Von to the off-voltage Voff and the amplitude Vd3 is approximately a half of the amplitude Vd1.

The ripple having the amplitude Vd3 is generated in the storage capacitor line CS2 due to the influence of each of the gate lines G2, G3, and the ripples are combined and the ripple having the amplitude Vd1 is generated. The ripple having the amplitude Vd3 from the gate line G3 and the ripple having the amplitude Vu1 from the gate line G4 are generated in the storage capacitor line CS2 and the ripples are canceled out each other and the ripple having the amplitude Vu3 is generated. The amplitude Vu3 is smaller than the amplitude Vu1 and is approximately a half of the amplitude Vu1.

Next, at the timing t3, the voltage applied to the gate lines G2, G3 is switched to the off-voltage Voff. Accordingly, the ripple having the amplitude Vd3 is generated in the storage capacitor lines CS1, CS3 and the ripple having the amplitude Vd1 is generated in the storage capacitor line CS2. The similar operations are executed in switching the voltage applied to the gate lines G1, G3 from the on-voltage Von to the off-voltage Voff and will not be explained.

According to the driving method of the third embodiment, in decreasing the voltage applied to the gate line G, the voltage applied to the gate line G changes at two timings to be switched from the on-voltage Von to the off-voltage Voff. Therefore, the amplitude of the ripple that is generated in the adjacent storage capacitor line CS at each timing is less likely to increase.

Therefore, in the driving method of the present embodiment, if the gate voltage applied to the gate line G is changed, the negative voltage-side amplitude of the ripple generated in the storage capacitor line CS that is arranged adjacent to the gate line G is limited to two kinds of Vd1 and Vd3 and the difference between the amplitude is reduced to be Vd3. Accordingly, compared to the amplitude difference Vd1 that is caused in switching the voltage applied to the gate line G from the on-voltage Von to the off-voltage Voff at once, the amplitude difference is reduced and variation in amplitude of the ripples generated in the storage capacitor line CS is less likely to be increased.

(3. Advantageous Effects of Third Embodiment)

(1) According to the third embodiment, in decreasing the voltage applied to the gate lines G2, G3, the voltage applied to the gate lines G2, G3 is changed two times at the timing t3 and the timing t4 to be switched from the on-voltage Von to the off-voltage Voff. Therefore, compared to the case in which the voltage is switched from the on-voltage Von to the off-voltage Voff only at the timing t3, the variation amount of the voltage at the timing t3 is reduced. Accordingly, compared to the case in which the voltage is switched from the on-voltage Von to the off-voltage Voff only at the timing t3, the amplitude of the ripple generated at the timing t3 is likely to be reduced. As a result, difference in the amplitude of the ripples generated in each storage capacitor line CS is less likely to increase and this improves display quality.

(2) According to the third embodiment, the drive circuit 12 of the liquid crystal display device 10 has the gate slope function for generating voltage between the on-voltage Von and the off-voltage. The drive circuit 12 generates the intermediate voltage Vm with using such a function. Therefore, a circuit for generating the intermediate voltage Vm is not necessarily built in the drive circuit 12, and this simplifies a configuration of the drive circuit 12 included in the liquid crystal display device 10.

### Other Embodiments

The present invention is not limited to the above embodiments described in the above description and the drawings. The following embodiments are also included in the technical scope of the present invention, for example.

(1) In the above embodiments, the voltage applied to the gate line G is switched from the on-voltage Von to the intermediate voltage Vm at the same timing as the voltage applied to the gate line G that is to be controlled next is switched from the off-voltage Voff to the on-voltage Von. However, it is not limited thereto. The timing of each of the above two switching operations may be set to be different from each other. In such a case, the amplitude of the ripples generated in the storage capacitor line CS is limited to the two amplitude including Vu1 (Vd1) and Vu3 (Vd3). Difference in the two kinds of amplitude is reduced to be Vu3 (Vd3). Accordingly, variation in the amplitude of the ripples generated in the storage capacitor line CS is likely to be reduced.

(2) In the above embodiments, the drive circuit 12 is separated from the liquid crystal panel 40. However, it is not limited thereto. For example, a part of the drive circuit 12 such as the CPU 20 may be mounted on the liquid crystal panel 40 as a gate driver or a source driver.

(3) In the above embodiments, in decreasing the voltage applied to the gate line G in two steps, the intermediate voltage Vm that is a half intermediate voltage is used as the intermediate voltage. However, it is not limited thereto. The intermediate voltage may be any other voltage as long as the voltage is between the on-voltage Von and the off-voltage Voff.

(4) In the above embodiments, in switching the voltage applied to the gate line G from the on-voltage Von to the off-voltage Voff, the voltage is switched from the on-voltage Von to the off-voltage Voff at two different timings. However, in switching the voltage applied to the gate line G from the off-voltage Voff to the on-voltage Von, the voltage may be switched from the off-voltage Voff to the on-voltage Von at two different timings. Accordingly, compared to the case in which the voltage applied to the gate line G is switched from the off-voltage Voff to the on-voltage Von at once, the difference in the positive voltage-side amplitude of the ripples generated in the storage capacitor line CS is likely to be reduced. Therefore, variation in the amplitude of the ripples generated in the storage capacitor line CS is less likely to increase.

(5) In the above embodiments, the LED 64 is used as the light source. However, any light source other than the LED may be used. The edge-light type device is used in the above embodiments. However, a direct-type device in which the light source is arranged on a back side of the light guide plate 62 may be used.

### EXPLANATION OF SYMBOLS

10: Liquid crystal display device, 12: Drive circuit, 14: Display, 18: Power source device, 20: CPU, 22: Memory, 24: Timer, 26: Timing setter, 28: Voltage generator, 30: Voltage applier, 40: Liquid crystal panel, 46: Pixel electrode, 48: Switching component, 50: Storage capacitor, 52: Counter electrode, P: Pixel, G: Gate line, S: Source line, CS: Storage capacitor line, V: Reference voltage, Von: On-voltage, Voff: Off-voltage, Vm: Intermediate voltage, Vd: Data voltage, Vc: Storage voltage, Vu, Vd: Amplitude of ripple

1. A method of driving a display device including gate lines and source lines that cross each other, display pixels each including a switching component and a pixel electrode and arranged for each crossing point, and storage capacitor lines that generate a storage capacitor between each storage capacitor line and each pixel electrode, the method comprising:
applying voltage to the gate lines including a first gate line, a second gate line and a third gate line, the display pixels including a first display pixel, a second display pixel and a third display pixel that are arranged along the source line, the first display pixel connected to the first gate line, the second display pixel connected to the second gate line that is arranged adjacent to the first gate line, and the third display pixel connected to the third gate line that is arranged adjacent to the second gate line and on an opposite side from the first gate line;
setting first timing at which the voltage applied to the first gate line drops and setting second timing at which the voltage applied to the second gate line and the third gate line rises such that the first timing is shifted from the second timing; and
lowering the voltage applied to the first gate line to switch off the first display pixel at the first timing and raising the voltage applied to the second gate line and the third gate line at the second timing to switch on the second image pixel and the third display pixel.

2. The method according to claim 1, wherein
the display device further includes a fourth display pixel connected to a fourth gate line that is arranged adjacent to the third gate line and on an opposite side from the second gate line, the method further comprising:
lowering the voltage applied to the second gate line and the third gate line to switch off the second display pixel and the third display pixel at third timing; and
raising the voltage applied to the fourth gate line to switch on the fourth display pixel at fourth timing that is shifted from the third timing.

3. The method according to claim 2, further comprising:
setting fifth timing that is prior to the third timing;
switching the voltage applied to the second gate line and the third gate line at the fifth timing from an on-voltage to an intermediate voltage that is between the on-voltage and an off-voltage; and
switching the voltage applied to the second gate line and the third gate line at the third timing from the intermediate voltage to the off-voltage.

4. The method according to claim 3, wherein the display device further includes:
a counter board on which a counter electrode is arranged and that is arranged to face a board on which the display pixels are arranged; and
a voltage generator configured to generate a voltage that is applied to the gate line to control flicker that is generated between the counter electrode and the pixel electrode of the display pixel that is arranged to face the counter electrode, and the voltage generator configured to generate the intermediate voltage that is applied to the gate line at the fifth timing.

5. A driving device of a display device including gate lines and source lines that cross each other, display pixels each including a switching component and a pixel electrode and arranged for each crossing point, and storage capacitor lines that generate a storage capacitor between each storage capacitor line and each pixel electrode, the driving device comprising:
a control device; and
memory storing instructions that, when executed, cause the control device to:
apply voltage to the gate lines including a first gate line, a second gate line and a third gate line, the display pixels including a first display pixel, a second display pixel and a third display pixel that are arranged along the source line, the first display pixel connected to the first gate line, the second display pixel connected to the second gate line that is arranged adjacent to the first gate line, and the third display pixel connected to the third gate line that is arranged adjacent to the second gate line and on an opposite side from the first gate line;
set first timing at which the voltage applied to the first gate line drops and set second timing at which the voltage applied to the second gate line and the third gate line rises such that the first timing is shifted from the second timing; and
lower the voltage applied to the first gate line to switch off the first display pixel at the first timing and raise the voltage applied to the second gate line and the third gate line at the second timing to switch on the second image pixel and the third display pixel.

6. The driving device of the display device according to claim 5, wherein the display device is a liquid crystal display device using a liquid crystal panel.

7. A television device comprising:
the driving device of a display device according to claim 5; and
a display device.

8. The driving device according to claim 5, wherein
the display device further includes a fourth display pixel connected to a fourth gate line that is arranged adjacent to the third gate line and on an opposite side from the second gate line, and
the instructions, when executed, further cause the control device to:
lower the voltage applied to the second gate line and the third gate line to switch off the second display pixel and the third display pixel at third timing; and
raise the voltage applied to the fourth gate line to switch on the fourth display pixel at fourth timing that is shifted from the third timing.

9. The driving device according to claim 8, wherein the instructions, when executed, further cause the control device to:
set fifth timing that is prior to the third timing;
switch the voltage applied to the second gate line and the third gate line at the fifth timing from an on-voltage to an intermediate voltage that is between the on-voltage and an off-voltage; and
switch the voltage applied to the second gate line and the third gate line at the third timing from the intermediate voltage to the off-voltage.

10. The driving device according to claim 9, wherein the display device further includes:
a counter board on which a counter electrode is arranged, the counter board arranged to face a board on which the display pixels are arranged, and
a voltage generator configured to generate a voltage to be applied to the gate line to control flicker generated between the counter electrode and the pixel electrode of the display pixel that is arranged to face the counter electrode, and the voltage generator configured to generate the intermediate voltage to be applied to the gate line at the fifth timing.
